(19) United States
(12) Patent Application Publication
(10) Pub. No.: US 2003/0165667 A1
(43) Pub. Date: Sep. 4, 2003

(54) Tougher, softer nonwoven sheet product

(76) Inventors: Didier Decker, Kanfen (FR); Joseph R. Guckert, Chester, VA (US); Brian P. Little, Midlothian, VA (US); Robert Anthony Marin, Midlothian, VA (US); Larry R. Marshall, Chesterfield, VA (US); Subhra K. Nath, Midlothian, VA (US); Nico Schmit, Grevenmacher (LU); Charles Stephen Schwartz, Richmond, VA (US); Faye N. Schwartz, Richmond, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/080,800

(22) Filed: Feb. 22, 2002

(51) Int. Cl. D04H 13/00; B32B 27/14; B32B 3/28

(52) U.S. Cl. 428/167; 428/196; 428/198; 442/334; 428/156; 428/172; 442/340

(57) ABSTRACT

The present invention relates to film-fibril plexifilamentary sheet products which demonstrate improved balance of toughness and softness combined with improved balance of air permeability and liquid barrier resistance, which are prepared by point bonding a nonwoven sheet on both sides by passing said sheet between embossing rolls at a combination of bonding temperature, pressure and residence time such that the majority of bond points are not bonded to the point of translucency. The present invention relates to the use of these products in rooflining materials.

### FIELD OF THE INVENTION

The present invention relates to improved nonwoven fabrics especially suitable for use in making rooflining sheet material.

### BACKGROUND OF THE INVENTION

Rooflining materials are sheet materials whose primary purpose is to act as a lining to the roof of a building to provide protection to a building against the effects of weather in conjunction with the actual roof itself. It is particularly desirable for rooflining materials to provide a barrier to keep wind and precipitation out of the building while still allowing moisture vapor to escape from the building. It is also desirable for rooflining materials to have good tensile properties, including toughness or work-to-break.

As rooflining can be exposed to extreme weather during construction, the liquid barrier properties of the sheet become extremely important. Traditionally, liquid barrier is achieved in a plexifilamentary film-fibril sheet product by more bonding of the sheet surface to create a high liquid flow-through resistance. One must be careful not to over bond the sheet to the point of forming perforations which would result in a reduced level of barrier. Bonding to high levels also has a negative impact on the softness of the sheet, which is important in allowing the sheet to be quiet during use, i.e., when the rooflining is subjected to flapping caused by strong winds.

The commercial plexifilamentary film-fibril sheet products sold by E. I. du Pont de Nemours and Company of Wilmington, Del., under the trade name of Tyvek® has been used in construction for providing a housewrap having good liquid barrier properties to prevent liquid water from penetrating into the house from the outside, while still permitting moisture vapor from inside the house to permeate through to the outside. These Tyvek® products are known as hard product, which is pressed on a smooth heated bonder roll. The hard product has the feel of slick paper and is used commonly in overnight mailing envelopes and for air infiltration barriers in construction applications. By this bonding process, both sides of the sheet are subjected to generally uniform, full surface contact thermal bonding.

In contrast, commercial plexifilamentary film-fibril sheet products that have been aimed at “soft” structure markets have traditionally been bonded with one side embossed with a “rib” pattern of discrete bond points, such as disclosed in Dempsey and Lee, U.S. Pat. No. 3,478,141, that uses a pair of rolls with sufficient heat and pressure that there are translucent “windows” formed in the fabric directly underneath the bosses on the embossing roll. The other side is embossed over essentially all of the surface with a “linen” pattern that is generated by use of an embossing roll that is engraved with a simulated linen pattern. The linen-by-rib design has subsequently been used for all of the commercial “soft structure” Tyvek® products.

Attempts to soften the product with techniques, such as jets of water, showed a tendency to delaminate the sheet because the linen pattern bonded side is essentially only a surface bond. Milder softening conditions have been used such as button breaking and creping, as disclosed in Dempsey, U.S. Pat. No. 3,427,376, which have resulted in adequate softening for many uses. However, further softening would be desirable for many end uses, including rooflining.

Lee and Simpson, U.S. Pat. No. 4,910,075 attempts to resolve this delamination problem in a water jet softened sheet by bonding both sides as a point bonded pattern, with total cross-sectional area at the tips of the bosses at about 4-7% of the sheet area being treated. The sheet produced by the process is bonded to the point of translucency in the 4-7% of the area under the bosses of the embossing roll and then subjected to water jet softening. The final product has a Hydrostatic Head of 20 cm and a Gurley Hill porosity of about 1 sec. This product is adequately soft and breathable and very functional for protective garments for use against dry particulate contaminants, but is only moderately protective against liquids after the aggressive softening action required to soften a structure that had been bonded to the point of translucency.

Further work on point bonding of plexifilamentary film-fibril products is disclosed in Miller, U.S. Pat. No. 4,091,137, which claims a point bonded structure with 8-155 bond points per square cm, that cover 3-25% of the sheet area, where the bond points are formed under sufficient heat and pressure so that they are essentially transparent, with the requirement that the bonded area have an average optical transmission of at least 50%. The aim of this invention was to improve visual uniformity of the product by the contrasting optical transmission between the bonded and unbonded areas.

The object of the present invention is to provide a rooflining material having an improved balance of properties including good work-to-break and softness.

### BRIEF SUMMARY OF THE INVENTION

One embodiment of the present invention is a flash spun film-fibril sheet material having a basis weight of between 55 and 115 g/m² which has been point bonded on both sides of said sheet material, wherein the bond points are not bonded to the point of translucency. The sheet material of the invention finds use as a rooflining material.

### DETAILED DESCRIPTION OF THE INVENTION

A plexifilamentary film-fibril sheet product that has an improved, unique balance of toughness or work-to-break, elongation, softness, air permeability and liquid barrier resistance has been developed by point bonding both sides of the sheet product using embossing rolls with bosses of sufficient size to give approximately 10-20% bonded area per side with 50-80 bosses/cm², while bonding at conditions where there is little or no formation of translucent spots at the point of contact of the sheet with the bosses. This product has high liquid barrier and dry particulate holdout while maintaining good breathability and has a 20-30% improvement in toughness over the commercial rib-by-linen bonded Tyvek® while simultaneously being 30-50% softer.

The starting point for the examples of the present invention is the lightly consolidated flash spun polyolefin sheet, in particular a flash spun polyethylene sheet, made by the process of copending application, U.S. Ser. No. 08/914,409. The sheet products for this invention are typically in the basis weight range of 55 to 115 g/m². However, it is expected that other nonwoven fabrics, including but not limited to melt-blown fabrics, melt-spun fabrics and composite fabrics, when subjected to the bonding process of the present invention, will obtain similar qualitative results.

The sheets are bonded by passing them through a pair of heated nips, with an embossing roll having typical point distributions of 50-80 bosses/cm², preferably 60-70 bosses/cm². The dimensions of the bosses are such that the bonded area is from about 10-20%, preferably about 13-17% of the area of the sheet, with the number of bond points in the range of 50-80 per sq. cm., preferably 60-70 bond points per sq. cm. The embossing rolls are typically in the range of 50-60 cm. in diameter and run against an elastomer-coated backup roll of diameter in the range of 45-55 cm., having a Shore A hardness of 50-80, with a preferred Shore A hardness of 65-70.

Line speed of the process can vary from about 100 to 250 m/min, and is preferably maximized for best economy. However, variations in line speed have an effect on residence time, such that line speed should be optimized based upon the desired residence time.

Bonding temperatures of the embossing rolls are typically in the range of 140-155° C. Bonding pressure should be the minimum to give necessary bonding for structural integrity and will vary with roll configuration and backup roll diameter, hardness and coating thickness. Bonding pressures useful in the present invention are from about 5-75 kN/m² of bonded area, preferably from about 20-60 kN/m², more preferably from about 38 to about 50 kN/m², but is typically less than about 50 kN/m² of bonded area (7.15 psi of bonded area). Once the product has been embossed on both sides by this process, the sheet is then mechanically softened using engaged pin rolls.

The process disclosed in Miller, U.S. Pat. No. 4,091,137, describes the use of a rubber backup roll with a surface hardness greater than 70 Shore D (preferably 80-90 Shore D), and an embosser roll loading in the range of 90 to 170 PLI (pounds per linear inch), preferably 120-130 PLI. The backup roll is required to be of said hardness in order to create a product with an average optical transparency of 50%. In order to achieve such optical transparency, it is necessary to use high pressures over a small contact area (‘footprint’) which maintains high pressure per bonded area of the embossed pattern. Example V of Miller discloses that a product created with a backup roll as soft as 60 Shore D (>100 Shore A) fails marginally to meet requirements of the Miller invention.

In contrast, according to the process of the present invention, a much softer backup roll of 60-70 Shore A is employed, in order to reduce the pressure applied from each point of the embossed pattern. (A hardness of 60-70 Shore A is equivalent to 16-22 Shore D hardness, higher values representing harder rubber compounds). The softer backup roll used according to the present invention enables improved bonding by reduction of the pressure applied by the bosses of the mating point bonding roll.

The residence time between any individual boss and the fabric should be less than about 55 milliseconds, preferably between about 3 and 30 milliseconds, more preferably between about 10 and 15 milliseconds.

In order to calculate the residence time, the contact length in the nip region between the embosser roll and rubber backup roll is needed. From the contact length, or “footprint”, the calculation for residence time can be found by the following:

Distance=rate*time

Time=distance/rate

Therefore,

Residence time=footprint/line speed.

This combination of process and apparatus improvements results in better point bonding according to the present invention, enabling point bonding such that the majority of bond points, and preferably all of the bond points, are not bonded to the point of translucency.

The film-fibril sheets of the present invention have unusual toughness, as measured by the work to break, considering the softness and other properties of the sheets and have a hydrostatic head of at least about 150 cm.

The point bonds of the sheets according to the present invention appear to form “ribs” that run in the machine direction of the sheet. The examples of the present invention set forth below are point bonded in a rib-by-rib pattern, i.e. rib bonded on both sides of the film-fibril sheet. It is believed that any of the number of conventional point bonding patterns will be effective to obtain the benefits of the present invention, when used according to the process disclosed herein.

The rib-by-rib sheet of the invention has been found to be soft, which is an advantage when the sheet is used as a rooflining material since the softer the sheet, the less noise the sheet makes when subjected to winds. This most often occurs when wind penetrates the space between the overlying roofing tiles and the roofing membrane, where the rooflining membrane is not supported by underlying insulation and thus hangs free.

In order to provide the necessary toughness and durability, the basis weight for the sheet of the present invention for use in rooflining should be preferably between 55 and 115 g/m². The sheet material of the present invention have a tensile strength in the machine direction and the cross direction of at least 74 (N/inch), an elongation in the machine direction and the cross direction of at least 15%, a nail tear strength in the machine direction and the cross direction of at least 45 N, and a Mullenburst bursting strength of at least 600 kPa.

### Test Methods

The critical parameters used to characterize this invention include the following tests:

WORK TO BREAK (WTB) of the sheet product is a measure of the toughness or resistance to tearing and puncture of the sheet and is determined by measuring the area under the stress-strain curve. Work to Break was measured according to test method DIN EN ISO 1924-2 using a Zwick 2.5 kN tester and a sample size of 2.54×20.32 cm. The tester was run at a speed of 10 cm/min, using a gage length of 12.7 cm and a clamp width of 11 cm. The samples are measured in the machine and cross directions of the product. A product that is tougher will yield a higher work to break value. Test results are reported in Newton-meters.

GURLEY-HILL POROSITY (GH) is a measure of the permeability of the sheet material for gaseous materials. In particular, it is a measure of how long it takes a volume of gas to pass through an area of material wherein a certain pressure gradient exists. Gurley-Hill porosity is measured in accordance with TAPPI T460 OM-88 using a Lorentzen & Wettre Model 121 D Densometer. This test measures the time for 100 mL of air to be pushed through a 28.7 mm diameter sample (one square inch) under a pressure of approximately 1.21 kPa (4.9 inches of water). The result is expressed in seconds that are frequently referred to as Gurley Seconds. A product with a Gurley Hill number of 4 sec will have twice the porosity as one with a Gurley Hill number of 8 sec and will be twice as breathable for the wearer's comfort.

HYDROSTATIC HEAD (HH) is a measure of the resistance of the sheet to penetration by liquid water under a static load. HH was measured according to test method DIN EN 20811 using a FX 3000 Hydrostatic Head Tester, available from Textest Instruments (Zurich, Switzerland), and a surface area of 100 cm². HH is measured in cm. A higher number indicates a product with greater resistance to liquid passage.

DELAMINATION STRENGTH of a sheet sample is measured using a constant rate of extension tensile testing machine such as the 2.5 kN Zwick tester. A 1.0 in. (2.54 cm) by 8.0 in. (20.32 cm) sample is delaminated approximately 1.25 in. (3.18 cm) by inserting a pick into the cross section of the sample to initiate a separation and delamination by hand. The delaminated sample faces are mounted in the clamps of the tester which are set 6 cm apart. The tester is started and run at a cross-head speed of 5.0 in./min. (12.7 cm/min.). The computer starts picking up force readings after the slack is removed in about 0.5 in. of crosshead travel. The sample is delaminated for about 14 cm during which 3000 force readings are taken and averaged. The average delamination strength is the average force divided by the sample width and is expressed in units of lb/in (N/cm). The test generally follows the method of ASTM D 2724-87, which is hereby incorporated by reference. The delamination strength values reported for the examples below are each based on an average of at least six measurements made on the sheet.

BASIS WEIGHT is determined by DIN EN ISO 536, which is hereby incorporated by reference, and is reported in g/m². The basis weights reported for the examples below are each based on an average of at least six measurements made on the sheet.

NAIL TEAR (MD AND CD) was determined by test method G. D. §5.4.1 and is reported in N. Using a Zwick 2.5 kN tester, in the axis of a 200×50 mm sample, a 3 mm hole is punched 50 mm from one end. A 2.5 mm nail is placed in the hole and fixed to the lower jaw of the test machine by means of a stirrup. The other end of the test sample is fixed in the upper jaw. The gage length used was 11 cm; the speed was 10 cm/min. The result is the maximum force measured.

TENSILE STRENGTH was determined by DIN EN ISO 1924-2, which is hereby incorporated by reference, with the following modifications. In the test, a 2.54 cm by 20.32 cm (1 inch by 8 inch) sample was clamped at its opposite ends in a Zwick 2.5 kN tester. The clamps were attached 12.7 cm (5 in) from each other on the sample. The sample was pulled steadily at a speed of 10 cm/min until the sample broke. The force at break was recorded in Newtons/cm as the breaking tensile strength.

ELONGATION TO BREAK of a sheet is a measure of the amount a sheet stretches prior to failure (breaking) in a strip tensile test. A 2.54×20.32 cm sample is mounted in the clamps of a Zwick 2.5 kN tester—set 5.0 inches (12.7 cm) apart—of a constant rate of extension tensile testing machine such as an Instron table model tester. A continuously increasing load is applied to the sample at a crosshead speed of 10 cm/min until failure. The measurement is given in percentage of stretch prior to failure. The test generally follows DIN EN ISO 1924-2.

THICKNESS of a sheet was determined by DIN EN 20534 and is reported in micrometers.

MULLENBURST BURSTING STRENGTH is a measure of the pressure at which a sheet sample will rupture, and is determined according to ISO 2758 and reported in kPa.

MOISTURE VAPOR TRANSMISSION RATE (MVTR) is a measure of the permeability of the sheet to moisture vapor, and is determined according to DIN 52615 and reported in g/m²/day.

### EXAMPLES

Examples 1-6 illustrate products of this invention for application as rooflining material using Tyvek® sheet made with a rib-by-rib embossing roll pattern. In each of these examples, the basis weight of the material is 60 g/m². Both embossers were coated with chrome. Pertinent properties of inventive samples 1-6 are given in Table 1. In each of these examples, the sheet passed sequentially over a pair of preheat rolls each having a diameter of 540 mm, through a first nip between a first rib embosser and a rubber back-up roll, and lastly through a second nip between a second rib embosser and a rubber back-up roll. The nip width was held constant at 40 mm.

Examples 1-2 were run at a line speed of about 182 meters/min (about 13.16 milliseconds residence time). The data in Table 1 for each of these examples are the average of two test samples in which the preheat roll temperature and the embossing roll temperatures were varied. The average preheat roll temperature for Example 1 was 100° C. The average preheat roll temperature for Example 2 was 120° C.

### Example 3

The data for this example in Table 1 is the average of two test samples. The residence time was 11.4 milliseconds in the first sample and 15 milliseconds in the second sample. The preheat roll temperature was controlled at 130° C. for both test samples.

### Example 4

The data for this example in Table 1 is the average of two test samples. The residence time was 12 milliseconds in the first sample and 15 milliseconds in the second sample. The preheat roll temperature was controlled at 105° C. for the first sample and 115° C. for the second sample.

### Example 5

The data for this example in Table 1 is the average of two test samples. The residence time was 12 milliseconds in the first sample and 15 milliseconds in the second sample. The preheat roll temperature was controlled at 105° C. for both samples. The samples were also measured for Mullenburst bursting strength and the average result was 550 kPa, as measured by test method ISO 2960.

Example 6 illustrates a typical product according to the present invention for use as a rooflining material using a rib-by-rib embossing roll pattern. The residence time was 15 milliseconds. The preheat roll temperature was 105° C. In addition to the properties listed in Table 1, Example 6 was also measured as having the following properties, listed below.

| | |
|---|---|
| Mullenburst bursting strength (ISO 2960): | 600 kPa |
| Gurley Hill porosity: | 55 seconds |
| Thickness: | 187 μm |
| Delamination strength: | 0.6 N |

TABLE 1
SAMPLE PROPERTIES

| | Bond Temp | MD Tensile | CD Tensile | MD Elongation | CD Elongation | MD Nail Tear | CD Nail Tear | HH |
|---|---|---|---|---|---|---|---|---|
| Ex. | (Deg. C.) | (N) | (N) | (%) | (%) | (N) | (N) | (cm) |
| 1 | 155/155 | 64 | 74 | 19 | 30 | 36 | 39 | 155 |
| 2 | 150/150 | 62 | 72 | 18 | 29 | 40 | 41 | 150 |
| 3 | 150/150 | 70 | 76 | 17 | 28 | 40 | 39 | 163 |
| 4 | 150/150 | 68 | 73 | 17 | 29 | 43 | 43 | 150 |
| 5 | 145/155 | 73 | 79 | 16 | 30 | 40 | 41 | 153 |
| 6 | 145/155 | 77 | 78 | 17 | 31 | 44 | 41 | 153 |

Example 7 (Control) is a commercial product using a linen by rib embossing pattern. The data for this example in Table 2 is the average for one quarter's commercial production. The preheat roll temperature was 95° C. and the residence time for preheat was 0.23 s. The bonding roll temperatures were 145° C. and 146° C. for the linen and rib sides of the sheet, respectively. The residence time for bonding was 10.2 milliseconds.

Example 8 illustrates a typical product according to the present invention for use as a rooflining material using a rib-by-rib embossing roll pattern. The product was processed using the same conditions as Example 6. The data in Table 2 is the average of 23-35 separate measurements for each property.

TABLE 2
SAMPLE PROPERTIES

| | Ex. 7 | Ex. 8 | delta |
|---|---|---|---|
| Thickness (μm) | 168 | 190 | +13% |
| Delamination strength (N) | 0.27 | 0.5 | +85% |
| Tensile-machine direction | 68.1 | 74.4 | +9% |
| (N/2.5 cm) | | | |
| Tensile-cross direction (N/2.5 cm) | 55.6 | 74.5 | +34% |
| Elongation-machine direction (%) | 9.5 | 17 | +80% |
| Elongation-cross direction (%) | 16.7 | 30 | +80% |
| Nail Tear-machine direction (N) | 46.7 | 42.6 | −9% |
| Nail Tear-cross direction (N) | 48 | 41 | −14% |
| Mullenburst (kPa) | 465 | 620 | +33% |
| MVTR (g/m²/day) | 1579 | 1703 | +8% |
| Hydrostatic Head (cm water) | 160 | 146 | −9% |
| Gurley Hill porosity (seconds) | 113 | 51 | −55% |
| Basis weight (g/m²) | 58.5 | 57.4 | −1.9% |
| Work to break-machine direction | 0.6 | 0.9 | +50% |
| (Nm) | | | |
| Work to break-cross direction (Nm) | 0.8 | 1.4 | +75% |

It can be clearly seen from these results that the products of this invention have a superior balance of properties for barrier sheet applications such as rooflining materials, having improved tensile strength, improved balance of machine direction/cross-direction balance of tensile strength, better elongation, improved work-to-break and higher Mullenburst bursting strength than the current commercial Tyvek® sheet of Example 7. It is believed that the reason for the improved properties of the sheets of the present invention, as compared to the current commercial product is the use of point bonds for both sides of the sheet, since the linen bonded side of the commercial product, which is bonded over the whole surface, restricts both breathability of the sheet and freedom of movement of the individual film-fibrils. The added freedom of movement of the inventive sheet that is point bonded on both sides results in the increased toughness and also significant improvement in softness.

We claim:

1. A flash spun film-fibril sheet material having a basis weight of between 55 and 115 g/m² which has been point bonded on both sides of said sheet material, wherein the bond points are not bonded to the point of translucency.

2. The sheet material of claim 1, wherein bond points encompass about 10-20% of the area of each side of the sheet.

3. The sheet material of claim 1 having a hydrostatic head of at least about 150 cm.

4. The sheet material of claim 1, that has from 50-80 bond points/cm² on each side of said sheet.

5. The sheet material of claim 1, having from 60-70 bond points/cm² on each side of said sheet, said bond points on each side of said sheet encompassing about 13-17% of the area of the sheet.

6. The sheet material of claim 1 having a ribbed point bonding pattern on both sides of the sheet.

7. The sheet material of claim 1 having a tensile strength in the machine direction and the cross direction of at least 74 (N/inch), an elongation in the machine direction and the cross direction of at least 15%, a nail tear strength in the machine direction and the cross direction of at least 45 N, and a Mullenburst bursting strength of at least 600 kPa.

8. A rooflining sheet material comprising the sheet material of claim 1.
